(19) United States
(12) Patent Application Publication
(10) Pub. No.: US 2021/0320317 A1
(43) Pub. Date: Oct. 14, 2021

(54) FUEL CELL SYSTEM FOR PORTABLE APPLICATIONS

(71) Applicant: ECOLE POLYTECHNIQUE FEDERALE DE LAUSANNE (EPFL), Lausanne (CH)

(72) Inventors: Mahmoud Hadad, Lausanne (CH); Paul Muralt, La Sarraz (CH)

(21) Appl. No.: 17/272,459

(22) PCT Filed: Sep. 2, 2019
(86) PCT No.: PCT/IB2019/057385

§ 371 Date: Mar. 1, 2021

(30) Foreign Application Priority Data
Aug. 31, 2018 (DE) 10 2018 121 379.4

(51) Int. Cl. H01M 8/1226; H01M 8/04007; H01M 8/0606; H01M 8/1246; H01M 8/1286

(52) U.S. Cl. CPC H01M 8/1226; H01M 8/04007; H01M 2008/1293; H01M 8/1246; H01M 8/1286; H01M 8/0606

(57) ABSTRACT

A fuel cell system component includes a glass ceramic composite.

### TECHNICAL FIELD

The disclosure relates to a fuel cell system component. The disclosure furthermore relates to a fuel cell system, a method for manufacturing a fuel cell, a method for manufacturing a fuel cell element and a use of a material according to the coordinate claims.

### BACKGROUND

In recent years, modern electronics have rapidly evolved and can nowadays accomplish almost any imaginable task. However, they still have the problem that absolutely adequate batteries do not exist. We are in fact witnessing a fundamental increase in power requirements of portable electronic devices, while the battery technology is not able to meet the power level and run-time demands.

Due to the superior energy density of chemical fuels, fuel cells could in principle present a solution to the battery problem. Fuel cells are electrochemical devices comprising an electrolyte that is sandwiched between two electrodes. During operation, a fuel (hydrogen, hydrocarbons, natural gas, etc.) is delivered to the anode side of the PEN (Positive electrode-Electrolyte-Negative electrode) membrane, and air to the cathode side. At the anode, the fuel is oxidized with oxygen arriving as O² ion from the electrolyte. The electrons pass to the anode conductor. At the cathode side, the used oxygen is replaced by oxygen uptake from the air, whereby the cathode conductor delivers the necessary electrons to create the O² ion at the electrolyte surface. The oxygen ions traverse the electrolyte layer to reach the anode side in a diffusion process. The respective electrochemical potentials on both sides create voltage difference of about 1V in the absence of current flow. In practice, a multitude of fuel cells are connected in series in order to provide a sufficiently high voltage and/or enough power for targeted applications.

The basic fuel cell technology selection for developing portable devices is a trade-off between the choice of fuels, gas processing, electrochemical conversion and manufacturing complexity. This puts solid oxide fuel cells (SOFCs) with a hydrocarbon fuel, i.e., propane/butane, on top of all other available power sources, including proton exchange membrane (PEM) and direct methanol fuel cells (DMFC). However, the positive attributes of SOFC come at the cost of high operating temperature, typically 800 to 1000° C.

The concept of micro-SOFC was proposed more than a decade ago, proposing advanced MEMS technology to meet miniaturization challenges. The operating temperature could indeed be lowered to less than 600° C. by employing thin film electrolytes in the thickness range of 100-500 nm. However, low scalability, high fabrication costs (clean-room infrastructure), low thermo-mechanical reliability, and a complex system integration were preventing them from becoming commercially available.

### SUMMARY

It is an object of the disclosure, per an embodiment, to solve or to at least diminish the above-mentioned disadvantages. In particular, it is an object of the present disclosure, per an embodiment, to find ways to simplify manufacturing of high temperature fuel cell systems, to make such systems sufficiently small for portable electronic applications and to optimize their thermo-mechanical stability.

This problem is solved, per an embodiment, by a fuel cell system component comprising a glass ceramic composite. The inventors have found that the use of glass ceramic composites in fuel cell systems may be advantageous because such materials have similar thermal properties, i.e. thermal expansion coefficients, as materials commonly in use in fuel cell systems, in particular SOFCs, and can help to avoid a thermal expansion mismatch between system components which dramatically decreases the thermal stress during thermal cycling. Furthermore, the handling and manufacturing of glass ceramic composites is comparably simple and straightforward. In this context, the term “fuel cell system” should be understood as any industrial system related to fuel cell technology, for example a fuel cell stack or a fuel cell unit or a fuel cell arrangement or a single fuel cell. A typical fuel cell system comprises at least one fuel cell and/or a heating system such as a hotplate, on which the fuel cell is typically installed, and/or a gas delivering unit and/or a gas processing unit (also referred to as reformer unit), the gas delivering unit and/or the gas processing unit typically including channels for supplying fuels like hydrogen and the like and/or oxygen to the fuel cell and/or the hotplate. In this context, a “fuel cell system component” can thus be a proper fuel cell (like for example a PEN membrane), a heating system or for example a gas processing unit, such as a micro-reformer.

In some embodiments, the glass ceramic composite comprises a fluorphlogopite mica in a borosilicate glass matrix, wherein the glass ceramic composite is typically MACOR.

Throughout this patent application, the term “MACOR” shall be understood as referring to a glass ceramic composite, in particular a fluorphlogopite mica in a borosilicate glass matrix, preferably with the following typical composition: 40% to 50% silica (S1O2) and/or 10% to 20% magnesium oxide (MgO) and/or 10% to 20% aluminum oxide (Al₂O3) and/or 5% to 15% potassium oxide (K₂O), and/or 5% to 10% boron trioxide (B₂O3) and/or 1% to 8% fluorine (F). In some embodiments, the glass ceramic composite has the before-mentioned composition and is not necessarily referred to as MACOR.

In some embodiments, the material MACOR in the sense of this application shall refer to a glass ceramic composite, in particular a fluorphlogopite mica in a borosilicate glass matrix, with the following typical composition: approximately 46% silica (S1O2), approximately 17% magnesium oxide (MgO), approximately 16% aluminum oxide (A12O3), approximately 10% potassium oxide (K2O), approximately 7% boron trioxide (B2O3) and approximately 4% fluorine (F). Throughout this application, the expression “approximately” shall be understood as referring to a tolerance of +/−20%, preferably +/−10%.

In some embodiments, the material MACOR stands for the machinable glass ceramic available under the trademark “MACOR®”, made available by Corning International. In this case, MACOR is basically a fluorphlogopite mica in a borosilicate glass matrix with a typical composition of 46% silica (S1O2), 17% magnesium oxide (MgO), 16% aluminum oxide (Al2O3), 10% potassium oxide (K2O), 7% boron trioxide (B2O3) and 4% fluorine (F). However, in this application, the term “MACOR” does not necessarily relate to this particular type of MACOR but can have any of the compositions explained above. In other words: “MACOR” in the sense of this application is not a trademark but a glass ceramic composite with any of the above-mentioned compositions.

The use of MACOR as glass ceramic composite may be advantageous, because MACOR has similar thermal expansion coefficient as material in use in SOFCs which avoids a thermal expansion mismatch between the SOFC membrane, and the substrate on which it is fixed. The typical thermal expansion coefficient of MACOR is between 8 and 12 ppm/K depending on the temperature, which is almost identical to a typical SOFC material stack, in particular an electrolyte layer, with a thermal expansion coefficient of 9 to 10 ppm/K. Alternatively or in combination with MACOR, other glass ceramic composites, in particular machinable glass ceramic composites, can also be used. It is also possible for the fuel cell system component to comprise MACOR and another glass ceramic composite and/or another material. One possible alternative to MACOR are low temperature cofired ceramics (LTCC) with a thermal expansion coefficient between 5.5 and 7.5 ppm/K. In some embodiments, the glass ceramic composite has a thermal expansion coefficient between 3 and 15 ppm/K, in particular between 5 and 12 ppm/K, preferably between 7 and 10 ppm/K. In some embodiments, the glass ceramic composite comprises a preferably synthetic mica and/or a glass matrix, typically a fluorphlogopite mica and/or a borosilicate glass matrix, preferably a fluorphlogopite mica in a borosilicate glass matrix.

In some embodiments, the fuel cell system component is a fuel cell. Manufacturing the fuel cell itself at least partly from glass ceramic composite may have the advantage that especially in this critical area of the fuel cell system, an advantageous thermal management may be obtained by means of the use of the glass ceramic composite. Alternatively, it is of course also possible for the fuel cell system component to be another component than the fuel cell, for example a hotplate or a micro-reformer.

In some embodiments, the fuel cell comprises a substrate made from the glass ceramic composite. A substrate made from glass ceramic composite and in particular from MACOR avoids a thermal expansion mismatch between the SOFC membrane, and the substrate on which it is fixed. This approach is an alternative to previously proposed micro-SOFC concepts of the prior art based on fabricating a PEN membrane on a silicon wafer with a thermal expansion coefficient of 3 ppm/K that derives significant thermal stress during thermal cycling. In some embodiments, an ion conducting thin sheet (1-200 μm thickness) with deposited anode and cathode electrodes with typical thicknesses of less than 1 μm are installed on a MACOR substrate or carrier. In some embodiments, depending on the method of cathode and anode preparation, the thickness of these layers can reach approximately 100 μm and/or up to approximately 300 μm.

In some embodiments, the fuel cell comprises a head made from the glass ceramic composite. A head made from glass ceramic composite and in particular from MACOR may be advantageous because of similar thermal properties. The fuel cell PEN membrane is thus sandwiched between two glass/ceramic parts to assure the proper contact between the electrical collectors (grid/mesh) and the electrodes (anode/cathode). In some embodiments, the head and/or the substrate comprise(s) one permeable aperture or multiple permeable apertures, wherein each of the multiple permeable apertures typically has an opening area of more than approximately 0.25 mm² to facilitate the gas access, in particular the access of fuel and oxygen, to the PEN membrane. In some embodiments, the head and/or the substrate essentially have the form of a frame, comprising a rim portion and an opening, wherein the opening typically forms the permeable aperture.

In some embodiments, the fuel cell comprises a multitude of functional parts, wherein the functional parts are sandwiched between the substrate and the head, wherein the substrate and the head may be preferably linked to each other by means of screws and/or by means of a glass connection created through structure heating and/or glass sealing. In some embodiments, the functional parts include for example an anode electrode and/or an ion conducting layer, such as an yttrium stabilized zirconium oxide (YSZ) sheet and/or a gadolinium doped cerium oxide (CGO) sheet and/or a current collector and/or another ion conducting layer or sheet and/or a cathode electrode. Linking the head and the substrate together by means of screws or structural heating is based on the overall system configuration in terms of thermal management by the help of fuel oxidation or increase of efficiency by hermetic sealing. Depending on the cases of use of the fuel cell, it is possible to choose either the linking by means of screws (or any other type of mechanical clamping) or the linking by means of structural heating. In this context it shall be pointed out that the glass ceramic composite, in particular MACOR, is especially adapted for creating a hermetic connection between the head and the structure of the fuel cell by means of structure heating and/or glass sealing. Alternatively, the substrate and the head can be linked in another way, for example by means of gluing or another sealing method. In some embodiments, the fuel cell comprises a mechanical clamping that links the head to the substrate. Screws are one example for such a mechanical clamping.

In an embodiment, the fuel cell system component is a heating system, in particular a hotplate, for a fuel cell system. In some embodiments, the heating system comprises at least two decoupled thermal zones, in particular a cold zone and a hot zone. The cold zone is typically an area, where the temperature is kept below 200° C., accessible to the conventional electrical and fluidic connections, such as standard plugs and the like. The hot zone typically comprises a micro-heater, preferably a resistive heater, that is used as pre-heating resource for a fuel cell unit PEN membrane and the fuel-processing unit for on-site hydrogen production and a post-combustor that can oxidize all unreacted fuel at the exhaust from the fuel cells. The thermal decoupling may be typically made through slender bridges that are configured to efficiently reduce the thermal conduction from one zone to another. The use of the glass ceramic composite, which is typically machinable, in the fuel cell component may have the advantage of facilitating the bridge fabrication, because removing parts from plates of such material can comparably easily be done by means of laser treatment, in particular laser cutting, and/or by means of drilling and/or by means of punching. In some embodiments, the heating system comprises at least one, preferably a multitude of heat decoupling bridge(s), typically arranged between the cold zone and the hot zone and configured to minimize a heat flow between the hot zone and the cold zone. Manufacturing the hotplate at least partly from glass ceramic composite with low thermal conductivity may have the advantage of effective thermal decoupling and efficient thermal management. Moreover, the use of the same material for the whole system structure avoids the issues of system integration and thermal stress. Alternatively, it is possible to foresee the hotplate in another material with similar properties.

In some embodiments, the heating system comprises a heater, preferably a thick-film heater, and a base plate, wherein the base plate is made from the glass ceramic composite, wherein the heating system preferably comprises a cover plate, wherein the cover plate is preferably made from the glass ceramic composite. In some embodiments, the heater is a resistive heater, preferably a thick-film resistive heater. In some embodiments, a thermal spreader is applied on the cover plate for uniform heat distribution. Such a hotplate architecture may be advantageous, because it leads to a very good heat management in the hotplate.

In some embodiments, the heating system comprises at least one bridge, preferably at least two bridges, typically at least three bridges, for thermally decoupling a cold zone of the heating system from a hot zone of the heating system. In some embodiments, the base plate comprises at least one bridge, preferably at least two bridges, typically at least three bridges, for thermally decoupling a cold zone of the base plate from a hot zone of the base plate. In some embodiments, the cover plate comprises at least one bridge, preferably at least two bridges, typically at least three bridges, for thermally decoupling a cold zone of the cover plate from a hot zone of the cover plate. In some embodiments, the base plate and the cover plate each comprise three bridges, wherein the bridges of the cover plate are configured to be congruent with the bridges of the base plate when the cover plate and the base plate are mounted together such as to form the heating system.

In some embodiments, the fuel cell system component is a gas processing unit, preferably a gas delivery unit and/or a gas chamber and/or micro-reformer and/or a fuel reformer and/or a post-combustor. In some embodiments, the gas processing unit is configured to convert a vaporized fuel, e.g. propane or butane, to a mixture of hydrogen/carbon monoxide-rich syngas using noble-metal (Platinum or Ruthenium) and/or ceramic (Ce—Zr0₂) catalysts. In this context, the term “micro-reformer” relates to a fuel cell system component in which the pressurized liquid butane from the fuel tank would be reformed into hydrogen/carbon monoxide-rich syngas for the electrochemical reduction at anode sides of the PEN element. One advantage, per an embodiment, of using glass/ceramic technology for the fabrication of the gas processing unit may be its easy 3D-structuration features, making it possible to manufacture complex fluidic channels. One other advantage, per an embodiment, may be effective thermal stress management due to the use of same material in the overall fuel cell system.

In some embodiments, the gas processing unit comprises a channel plate made from the glass ceramic composite, wherein the channel plate preferably comprises a channel network and a reformer chamber, wherein the channel network at least partly surrounds the reformer chamber, wherein the channel preferably comprises a multitude of fluidic channels and/or a multitude of essentially and generally parallel micro-channels.

In some embodiments, the gas processing unit comprises a reformer cover made from the glass ceramic composite, wherein the reformer cover preferably comprises a catalyst loading window and/or a channel access hole. Having the reformer cover made from the glass ceramic composite, in particular MACOR, may have the advantage of further improving the thermal behavior of the gas processing unit, thereby reducing the thermal stress on the component. Alternatively, it is also possible to have the reformer cover made from another material.

In some embodiments, the gas processing unit comprises at least one bridge, preferably at least two bridges, typically at least three bridges, for thermally decoupling a cold zone of the gas processing unit from a hot zone of the gas processing unit. In some embodiments, the channel plate comprises at least one bridge, preferably at least two bridges, typically at least three bridges, for thermally decoupling a cold zone of the channel plate from a hot zone of the channel plate. In some embodiments, the reformer cover comprises at least one bridge, preferably at least two bridges, typically at least three bridges, for thermally decoupling a cold zone of the reformer cover from a hot zone of the reformer cover. In some embodiments, the channel plate and the reformer cover each comprise three bridges, wherein the bridges of the reformer cover are configured to be congruent with the bridges of the channel plate when the reformer cover and the channel plate are mounted together such as to form the gas processing unit.

In some embodiments, the gas processing unit comprises a heating system according to the disclosure. This may have the advantage to lead to a compact construction of the fuel cell system.

In some embodiments, the heating system is configured to provide an initial heating in order to reach a minimum temperature (e.g. approximately 400° C.) to start the reforming reaction in the gas processing unit.

A fuel cell system according to an embodiment of the disclosure comprises a fuel cell system component according to the disclosure, in particular a fuel cell according to the disclosure and/or a heating system according to the disclosure and/or a gas processing unit according to the disclosure. Having more than one fuel cell system component, for example a fuel cell and another fuel cell system component, comprise the glass ceramic composite or having several fuel cell components made from the glass ceramic composite may be advantageous because like this the thermal stress on the entire fuel cell system is reduced by the fact that the glass ceramic composite, in particular MACOR, is used at several locations inside the fuel cell system. Thereby, the behaviour of large parts of the fuel cell system under heat is uniformized, and this results in better resistance to heat stress of the overall fuel cell system. In some embodiments, all fuel cell system components form a single stack, wherein the single stack is essentially cuboid, meaning that the stack has a quasi-rectangular base area, e.g. a rectangular base area which might comprise certain recesses, salients, inlets or the like.

In some embodiments, the fuel cell system comprises a base plate according to one of the embodiments described above, a cover plate according to one of the embodiments described above, a channel plate according to one of the embodiments described above and a reformer cover according to one of the embodiments described above, wherein the base plate, the cover plate, the channel plate and the reformer cover typically each comprise equal amounts of bridges, preferably three bridges. In some embodiments, the base plate, the cover plate, the channel plate and the reformer cover are configured in such a way the bridges form one or more bridge stack(s) when the base plate, the cover plate, the channel plate and the reformer cover are piled upon each other to at least partly build the fuel cell system. In some embodiments, all bridges have the same dimensions, at least approximately. In some embodiments, the bridges in each bridge stack are at least essentially congruent.

In some embodiments, at least two parts of the fuel cell system made from the glass ceramic composite, preferably all parts of the fuel cell system made from the glass ceramic composite, are linked to each other by means of screws and/or by means of a glass connection created through structure heating and/or sealing. The fact of linking several fuel cell system components in the fuel cell system by means of screws or by means of the glass connection created through structure heating may have the advantages mentioned above, namely allowing a controlled exothermic reaction in the case of screws and a hermetic sealing in the case of structure heating and/or glass sealing. In some embodiments, more generally, any type of mechanical clamping is used for the linking, for example screws.

In some embodiments, the base plate, the cover plate, the channel plate, the reformer cover, the substrate and the head of the fuel system are linked to each other by means of glass connections. In some embodiments, each glass connection forms a hermetic sealing. The glass connections are typically created by piling the different components of the fuel cell system, which comprise the glass ceramic composite, onto each other and by then heating them up to approximately 1050° C. in order to make the glass ceramic composite form the glass connections between the different components comprising the glass ceramic composite. The glass connections formed like this can also be referred to as a single glass connection, since all components are then typically interlinked. In some embodiments, the fuel cell system thus comprises a multitude of glass connections and/or a single glass connection.

A use of the material MACOR according to the disclosure is a use of this material in a fuel cell system. In an embodiment, the fuel cell system is a portable fuel cell system. In an embodiment, the fuel cell system has a mass of up to 5 kg or up to 10 kg, preferably up to 2 kg, typically up to 1 kg or up to 300 g.

A use of a glass ceramic composite with fluorphlogopite mica in a borosilicate glass matrix according to the disclosure is a use of such a glass ceramic composite in a fuel cell system.

A method for manufacturing a fuel cell according to an embodiment of the disclosure comprises the steps:

deposition of a first electrode on top of a, ion conducting sheet, preferably a YSZ sheet, preferably by means of a shadow mask,

installation of a first conductive grid on a substrate comprising a glass ceramic composite, wherein the substrate is typically made from MACOR,

installation of the ion conducting sheet with the deposited first electrode on the first conductive grid, such that a contact between the first electrode and the first conductive grid is established,

polishing down the ion conducting sheet, preferably to a thickness of 30 pm or less,

deposition of a second electrode on top of the ion conducting sheet, preferably by means of a shadow mask,

installation of a second conductive grid on the second electrode, and

preferably installing a head on top of the second conductive grid, such as to press the second conductive grid against the second electrode, wherein the head typically comprises a glass ceramic composite, wherein the head is typically made from MACOR.

In an embodiment, the first electrode is an anode and/or the second electrode is a cathode.

A method for manufacturing a fuel cell element, per an embodiment, comprises the step:
polishing down an ion conducting sheet, preferably to a thickness of 30 pm or less.

In some embodiments, the ion conducting sheet is a YSZ sheet. In some embodiments, the fuel cell element is a fuel cell membrane. In some embodiments, the fuel cell membrane is fabricated by polishing the ion conducting sheet down to a thinner thickness such as to create a fuel cell membrane with a thickness of 30 pm or less.

Compared to a traditional bottom-up manufacturing for portable fuel cells based on silicon industry and microfabrication, a top-bottom manufacturing is an interesting alternative, because it makes it possible to use a more compatible substrate to the PEN membrane, e.g. MACOR, in terms of thermal and mechanical properties, and moreover because it reduces the fabrication complexity by avoiding to go through multiple microfabrication steps and because it facilitates the complete system integration and finally lowers the costs of device fabrication.

### BRIEF DESCRIPTION OF THE FIGURES

In the following, the disclosure is described in detail by means of drawings, wherein show:

FIG. 1: A schematic representation of a method for manufacturing a fuel cell according to the disclosure,

FIG. 2: A schematic representation of a heating system according to the disclosure,

FIG. 3: A schematic representation of a combination of a gas processing unit according to the disclosure and a heating system according to the disclosure, and

FIG. 4: A schematic representation of a fuel cell system according to the disclosure.

### DETAILED DESCRIPTION

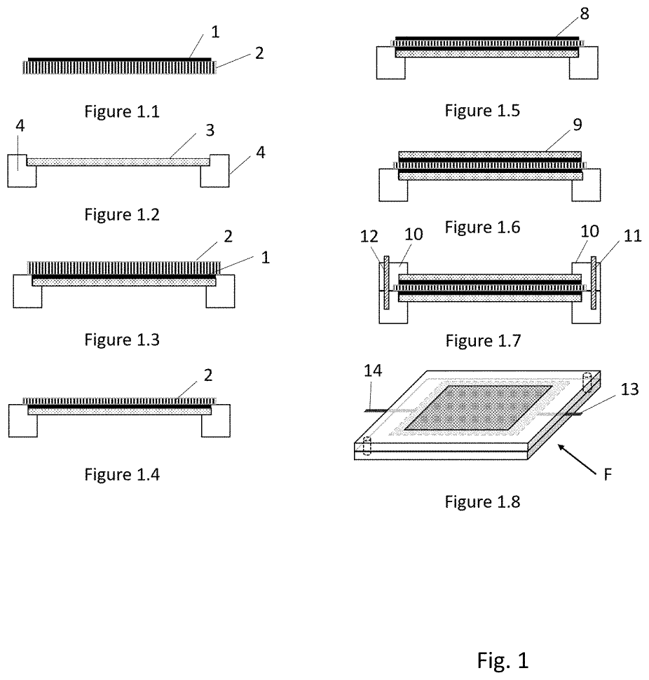

FIG. 1 shows a schematic representation of a method for manufacturing a fuel cell F according to an embodiment of the disclosure.

The fabrication process starts (see FIG. 1.1) with the deposition of anode 1 on a commercially available YSZ sheet 2 that can for example come with a minimum thickness of 100 μm and surface area of 1 cm² or more. In some embodiments, the thickness of the YSZ sheet 2 is between 100 μm and 500 μm, preferably approximately 300 μm. In order to avoid an extensive clean-room process, the deposition is made through a shadow mask to define the electrode size and the active area.

FIG. 1.2 shows the installation of a first conductive grid 3 as current collector on top of an essentially square, frame-like MACOR substrate 4. The MACOR substrate 4 typically has a thickness (corresponding to the vertical direction in FIG. 1.2) of approximately 1 mm. Two distinct parts of the MACOR substrate 4 are visible in FIG. 1.2 (and the following FIGS. 1.3 to 1.7) because these Figures show cuts through the fuel cell F (shown in FIG. 1.8).

FIG. 1.3 shows how the combination of the anode 1 and the YSZ sheet 2 is placed on top of the conductive grid 3, such that a contact between the anode 1 and the conductive grid 3 is established. After that, the sample is heated up to approximately 1050° C. with a heating rate of 4° C./minute and the entire partial fuel cell structure shown in FIG. 1.3 is then exposed to a dwelling time of 30 minutes in order to join the YSZ sheet 2 to MACOR substrate 4.

Afterwards, the YSZ sheet 2 is mechanically polished down using diamond pads to 30 μm or less to facilitate the oxygen ion conduction at an intermediate temperature, namely a temperature of 700° C. or less. The polished-down YSZ sheet 2 can be seen in FIG. 1.4.

Next (shown in FIG. 1.5) a cathode 8 is deposited through a shadow mask onto the polished-down YSZ sheet 2 to complete the PEN membrane structure.

Finally, a second conductive grid 9 is installed on top of the cathode 8 for uniform current distribution (see FIG. 1.6).

To assure the proper connection of the second conductive grid 9 to the cathode 8, the second conductive grid 9 is pressed to the membrane using a head 10 made from MACOR with a thickness of 1 mm (see FIG. 1.7). The connection of the MACOR substrate 4 and the head 10 around the PEN membrane can be done either via screws 11, 12 or via structure heating up to 1050° C. (the same principle as for MACOR-YSZ joining as explained above). FIG. 1.7 shows the alternative with screws 11, 12.

FIG. 1.8 shows a schematic, perspective view of the final fuel cell F. In addition to the previously described elements of the fuel cell F, FIG. 1.8 also shows two electrical connections 13, 14. The fuel cell F shown in FIG. 1.8 is essentially square. It can for example have a side length between 1 cm and 10 cm.

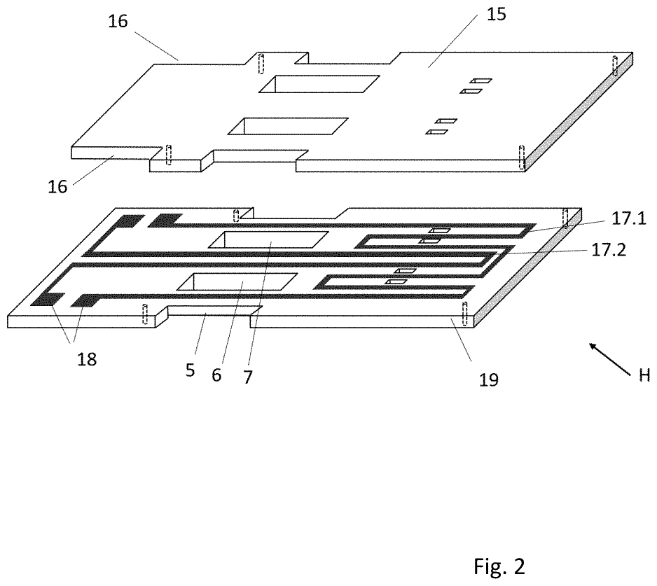

FIG. 2 shows a schematic representation of a heating system H according to the disclosure. The heating system H comprises a base plate 19 and a cover plate 15. The base plate 19 comprises a thick-film heater comprising two separate heating strips 17.1 and 17.2, namely an outer heating strip 17.1 and an inner heating strip 17.2. Two separate heating strips may have the advantage of being able to provide a more uniform heat distribution, but a heater comprising a single heating strip is in principle also possible. The base plate 19 comprises a hot zone and a cold zone. The hot zone and the cold zone are separated by three parallel bridges, namely a first bridge 5, a second bridge 6 and a third bridge 7. The cold zone comprises four electrical pads 18 for connecting the heater to one or more power sources (only two electrical pads 18 are equipped with reference signs and no power source is shown). The hot zone is the area of the base plate 19 which is located on the other side of the bridges 5, 6, 7 when looking at the bridges form the cold zone. The cover plate 15 comprises two opened areas 16 configured to be located on top of the electrical pads 18 when the heating system H is mounted. The arrangement of a hot zone and a cold zone may have the advantage to make it possible to use standard electrical and fluidic interconnections.

When the heating system H is mounted, the heater is sandwiched between the base plate 19 the cover plate 15, which are both made from MACOR. Thus, when the heating system H is assembled, the heater is embedded within two MACOR plates with opened access to electrical pads 18. The heater itself is fabricated using thick film processing, such as screen-printing of resistive filament, for example through a shadow mask. The material selection is dependent on the operation temperature. The filamentary structure is chosen to obtain the required resistance. In some embodiments, the filament width is 1 mm with the same spacing size between the different meanders of the filament. Narrower structures can be fabricated for better heat distribution. The resistance of the heater should be stable, drift-free and ideally present a significant temperature coefficient of resistance (TCR) that allows the heater to perform as temperature sensor at the same time. At elevated temperature, platinum thick-film is one of the most suitable solutions. The operation temperature of platinum thick-film should ideally be limited to 800° C.—the sintering temperature of platinum paste.

Another element of the disclosure, per an embodiment, is a gas processing unit for delivering the fuel from the cold zone to the fuel cell membrane, as well as on-site hydrogen production to avoid carbon coking at electrode materials. The idea is to reform the hydrocarbon fuel, propane for instance, into syngas (Fh+CO), with an on-site fuel processor. The conventional reforming systems are not compatible with micro-scale solid oxide fuel cells (SOFCs) as the system is required to be miniaturized and compact, to have accurate reforming control, as well as, showing rapid start-up and shutdown time. Therefore, foreseeing a MACOR-based gas processing unit is advantageous for a fuel cell system to have complete system compatibility and thermal shock resistivity during thermal cycling.

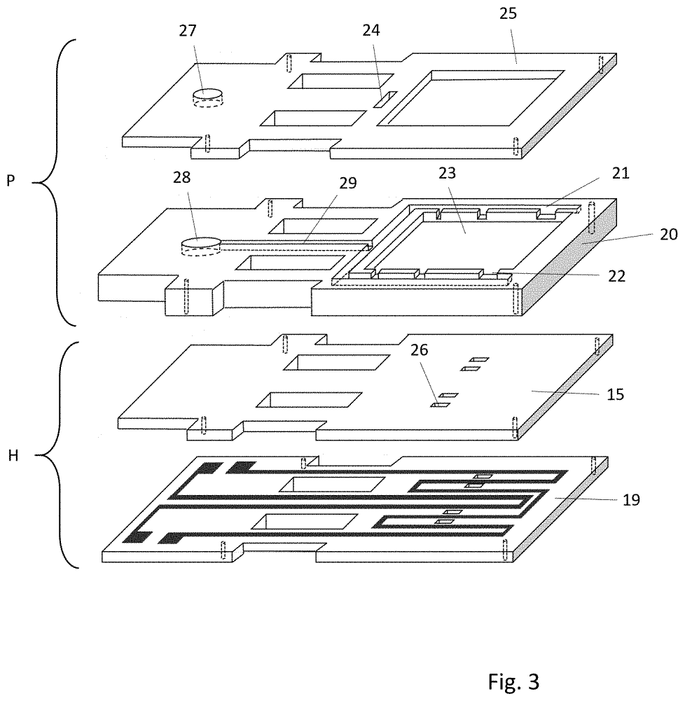

FIG. 3 shows schematic representation of a combination of a gas processing unit P according to an embodiment of the disclosure and a heating system H according to the disclosure. The gas processing unit P comprises a channel plate 20 made from MACOR as well as a reformer cover 25 also made from MACOR. It becomes clear from FIG. 3 that the gas processing unit 20, is configured to be installed on top of the heating system H, which can also be referred to as hotplate. In some embodiments, the gas processing unit 20 is configured to be installed below the heating system H. The cover plate 15, the base plate 19, the channel plate 20 and the reformer cover 25 can obviously also be referred to as “layers” of the structure shown in FIG. 3.

The channel plate 20 comprises a multitude of fluidic channels 21 (only one of them is equipped with reference signs for the sake of simplicity), a multitude of micro-channels 22 (only one of them is equipped with reference signs for the sake of simplicity) and a reformer chamber 23 for hosting parts of a fuel cell F (like the one shown in FIG. 1). The fluidic channels 21 are placed partly around a reformer chamber 23 and allow feeding of fuel to the fuel cell through the micro-channels 22 located on two lateral sides of the reformer chamber 23. This configuration may have the advantage to increase the entrance contact area for the fuel, thus improving thermal uniformity. The width of the fluidic channels 21 is less than 1 mm. The channel plate 20 can be seen as a micro-flow distributing structure containing a series of parallel short micro-channels 22 in a width range of 0.3 mm to 1 mm for improving flow dispersion within the reformer chamber 23. After reaction in the fuel cell, the oxidized fuel passes through the heating system H via small openings 26 in the cover plate 15 and the base plate 19 of the heating system H.

The channel plate 20 is covered with the reformer cover 25. The reformer cover 25 comprises a catalyst loading window 24 and a channel access hole 27. The channel plate 20 comprises a channel access well 28 and a feeder 29. It becomes clear from FIG. 3 that a fuel can be fed to the reformer chamber 23 through the channel access hole 27, the channel access well 28, the feeder 29, the fluidic channels 21 and the micro-channels 22 when the gas processing unit is mounted. The catalyst loading window 24 makes it possible to place a catalyst (not shown) at the end of the feeder 29, thereby allowing straight-forward catalysis of the fuel. The assembly of the different layers 15, 19, 20, 25 of the structure shown in FIG. 3 can be done either by screws or by means of heating up to 1050° C. to benefit from the glass part of MACOR for sealing. It can be observed in FIG. 3 that not only the base plate 19 of the heating system H comprises three parallel bridges: also the layers 15, 20 and 25 each comprise three bridges, wherein the bridges are configured to be congruent when the four layers 15, 19, 20 and 25 are mounted in a stacked fashion on top of each other. This configuration helps to improve the separation between a hot zone and a cold zone. In some embodiments, each layer 15, 19, 20, 25 comprises at least one, preferably at least two, more preferably at least three bridges. However, also four, five or more bridges can be foreseen.

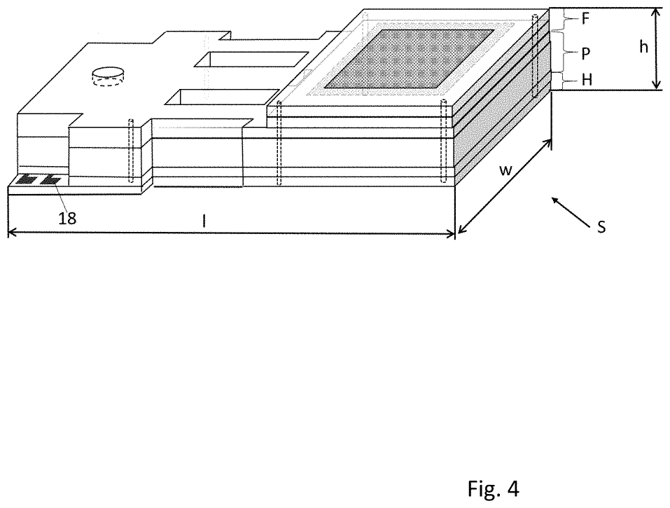

FIG. 4 shows a schematic representation of a fuel cell system S according to the disclosure. In particular, the fuel cell system S comprises the heating system H shown in FIGS. 2 and 3, the gas processing unit P shown in FIG. 3 and the fuel cell F shown in FIG. 1. The fuel cell F is installed on top of the gas processing unit P and the gas processing unit P is installed on top of the heating system H. The mounting of these three components F, P, H of the fuel cell system S, namely of the fuel cell F, the heating unit h and the gas processing unit P, can either be carried out mechanically, using screws like the screws 11, 12 shown in FIG. 1, or by glass sealing, using the sealing capacities of the MACOR's glass component, as explained before. The electrical connections can be established with the electrical pads 18 using standard methods thanks to the thermally decoupled structure, namely the before-mentioned two zones separated by the bridges 5, 6 and 7 (these reference signs to the bridges are not shown in FIG. 4 but are shown in FIG. 2). The fuel cell system S shown in FIG. 4 typically has a length l between 4 cm and 7 cm, a width w between 3 and 5 cm and a height h between 0.4 cm and 1 cm, preferably approximately 0.8 cm. In some embodiments, a fuel system like the one shown in FIG. 4 has a length I between 5 cm and 15 cm, a width w between 3 cm and 10 cm and a height h between 0.4 cm and 1 cm, preferably approximately 0.8 cm. The bridges 5, 6, 7 typically each have a length between 0.8 cm and 1.2 cm, preferably approximately 1 cm, and each have width between 0.4 cm and 0.6 cm, preferably approximately 0.5 cm. Widths and lengths of the bridges are measured in the same directions as the respective width w and length l of the fuel cell system S. Other dimensions are possible for the bridges 5, 6, 7 and/or the fuel cell system S, depending on the respective needs. The fuel cell system S with these dimensions can be expected to deliver powers up to 10 W, with having an operating area of 10 cm², and further assembly of the cells, such as 3-dimensional stacking, can lead to higher power delivery up to several hundreds of watts.

In some embodiments, a post combustor (not shown), preferably a post combustor similar or essentially identical to the channel plate 20, is placed below the heating system H to guarantee that remaining fuel is being flared and/or oxidized before leaving the fuel cell system S. The post combustor is typically made from the same material as the channel plate, preferably from MACOR. The fuel cell system S and all of its components are particularly adapted for use in portable applications.

In certain embodiments, the present disclosure takes a unique approach by combining large scale fuel cell technology with advanced micro- and nanotechnology to produce a miniaturized fuel cell system with embedded microchannel channels, resistive heater and gas reformer. This miniaturized fuel cell system is based on a machinable glass-ceramic, for example MACOR. With this approach, it is possible to build a complete and compact stack of fuel cells to be used as power source for portable applications. The high compatibility of MACOR's thermal expansion coefficient with a fuel cell stack reduces the impact of thermal stress during thermal cycling. Moreover, the glass part of MACOR can facilitate the hermetic sealing of all components. Finally, the use of MACOR as machinable ceramic allows complex device designs and reduces the cost of fabrication significantly.

In some embodiments, the disclosure can have the advantage of proposing a simplified manufacturing method to build an integrated fuel cell, especially a solid oxide fuel cells (SOFC).

In some embodiments, the disclosure can have the advantage of at least partly solving the thermomechanical challenge of using high temperature fuel cell technology for portable applications.

In some embodiments, the disclosure can have the advantage of presenting a modular fuel cell unit that can provide a scalable power source delivering electrical powers of a wide range, for example from 5 W up to more than 100 W.

The invention is not limited to the preferred embodiments described here. The scope of protection is defined by the claims.

Furthermore, the following claims are hereby incorporated into the Description of Preferred Embodiments, where each claim may stand on its own as a separate embodiment. While each claim may stand on its own as a separate embodiment, it is to be noted that—although a dependent claim may refer in the claims to a specific combination with one or more other claims—other embodiments may also include a combination of the dependent claim with the subject matter of each other dependent or independent claim. Such combinations are proposed herein unless it is stated that a specific combination is not intended. Furthermore, it is intended to include also features of a claim to any other independent claim even if this claim is not directly made dependent to the independent claim.

It is further to be noted that methods disclosed in the specification or in the claims may be implemented by a device having means for performing each of the respective acts of these methods.

All the features and advantages, including structural details, spatial arrangements and method steps, which follow from the claims, the description and the drawing can be fundamental to the invention both on their own and in different combinations. It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

### LIST OF REFERENCE SIGNS

1 Anode

2 YSZ sheet

3 First conductive grid

4 MACOR substrate

5 First bridge

6 Second bridge

7 Third bridge

8 Cathode

9 Second conductive grid

10 Head

11, 12 Screws

13, 14 Electrical connection

15 Cover plate

16 Opened area

17.1, 17.2 Heating strips

18 Electrical pads

19 Base plate

20 Channel plate

21 Fluidic channels

22 Micro-channels

23 Reformer chamber

24 Catalyst loading window

25 Reformer cover

26 Evacuation openings

27 Channel access hole

28 Channel access well

29 Feeder

F Fuel cell

H bleating unit

P Gas processing unit S Fuel cell system

h Height (of fuel cell system)

l Length (of fuel cell system) w Width (of fuel cell system)

1. Fuel cell system component, wherein the fuel cell system component comprises a glass ceramic composite.

2. Fuel cell system component according to claim 1, wherein the glass ceramic composite comprises a fluorphlogopite mica in a borosilicate glass matrix, wherein the glass ceramic composite is MACOR.

3. Fuel cell system component according to claim 1, wherein the fuel cell system component is a fuel cell (F).

4. Fuel cell system component according to claim 3, wherein the fuel cell (F) comprises a substrate made from the glass ceramic composite.

5. Fuel cell system component according to claim 3, wherein the fuel cell (F) comprises a head made from the glass ceramic composite.

6. Fuel cell system component according to claim 5, wherein the fuel cell (F) comprises a multitude of functional parts, wherein the functional parts are sandwiched between the substrate and the head, wherein the substrate and the head are linked to each other by screws and/or by a glass connection created through structure heating and/or glass sealing.

7. Fuel cell system component according to claim 1, wherein the fuel cell system component is a heating system (H) for a fuel cell system (S).

8. Fuel cell system component according to claim 7, wherein the heating system (H) comprises:
a heater; and
a base plate,
wherein the base plate is made from the glass ceramic composite, wherein the heating system comprises a cover plate, wherein the cover plate is made from the glass ceramic composite.

9. Fuel cell system component according to claim 7, wherein the heating system (H) comprises at least one bridge for thermally decoupling a cold zone of the heating system (H) from a hot zone of the heating system (H).

10. Fuel cell system component according to claim 1, wherein the fuel cell system component is a gas processing unit (P).

11. Fuel cell system component according to claim 10, wherein the gas processing unit (P) comprises a channel plate made from the glass ceramic composite, wherein the channel plate comprises a channel network and a reformer chamber, wherein the channel network at least partly surrounds the reformer chamber, wherein the channel network comprises a multitude of fluidic channels and/or a multitude of generally parallel micro-channels.

12. Fuel cell system component according to claim 10, wherein the gas processing unit (P) comprises a reformer cover made from the glass ceramic composite, wherein the reformer cover comprises a catalyst loading window and/or a channel access hole.

13. Fuel cell system component according to claim 10, wherein the gas processing unit (P) comprises at least one bridge, for thermally decoupling a cold zone of the gas processing unit (P) from a hot zone of the gas processing unit (P).

14. Fuel cell system component according to claim 10, wherein the gas processing unit (P) comprises a heating system (H).

15. Fuel cell system (S) comprising a fuel cell system component (F) according to claim 1.

16. Fuel cell system (S) according to claim 15, wherein at least two parts of the fuel cell system (S) made from the glass ceramic composite are linked to each other by screws and/or by a glass connection created through structure heating and/or glass sealing.

17. Method for manufacturing a fuel cell (F) according to claim 3, comprising the steps:
deposition of a first electrode on top of an ion conducting sheet by means of a shadow mask,
installation of a first conductive grid on a substrate comprising a glass ceramic composite, wherein the substrate is made from MACOR,
installation of the ion conducting sheet with the deposited first electrode on the first conductive grid, such that a contact between the first electrode and the first conductive grid is established,
polishing down the ion conducting sheet,
deposition of a second electrode on top of the ion conducting sheet,
installation of a second conductive grid on the second electrode, and
installing a head on top of the second conductive grid, such as to press the second conductive grid against the second electrode, wherein the head comprises a glass ceramic composite, wherein the head is made from MACOR.

18. Method for manufacturing a fuel cell element, comprising the step:
polishing down an ion conducting sheet to a thickness of 30 μm or less.

19. Use of the material MACOR in a fuel cell system (S).

20. (canceled)
